(19) United States
(12) Patent Application Publication
(10) Pub. No.: US 2009/0282668 A1
(43) Pub. Date: Nov. 19, 2009

(54) Method and device for assemblying torsion box structures for an aircraft

(76) Inventor: Desiderio Sanchez-Brunete Alvarez, Madrid (ES)

Correspondence Address: WENDEROTH, LIND & PONACK, L.L.P., 1030 15th Street, N.W.,, Suite 400 East, Washington, DC, 20005-1503, US

(21) Appl. No.: 12/232,728

(22) Filed: Sep. 23, 2008

(30) Foreign Application Priority Data
May 19, 2008 (ES) P200801447

(51) Int. Cl. B23P 11/00; B25B 27/14

(52) U.S. Cl. 29/428; 29/281.1

(57) ABSTRACT

The method basically consists of mounting the spars (2, 2′) and the ribs (3) with reference to the skin (4) in such a manner that, once the spars (2, 2′) are positioned with their proper reference in an assembly jig (12), the ribs (3) are transversely positioned with the condition that they are adjusted making contact against the inner surface of the skin (4).

The device comprises a template element (15) which is used for previously providing the skin with the theoretical form it must acquire once mounted, and to firmly maintain that theoretical form by including means for securing and tightening (16) the skin (4), as well as means (17, 18, 19, 20) for supporting and positioning the skin (4).

### OBJECT OF THE INVENTION

As stated in the title of this descriptive specification, the present invention has the aim of providing a method for assembly of a torsion box type structure for aeronautical use ensuring certain minimum dimensional tolerances in the aerodynamic outer surface of the skin, simplifying the assembly method and eliminating unnecessary assembly operations.

### TECHNICAL FIELD OF THE INVENTION

As revealed in the previous section, the present invention has application in the aeronautical industry, in the technical field of aircraft structures, particularly torsion box type structures.

Torsion box type structures, simply named as torsion boxes, whose assembly method this invention refers to, are structures well known in the technical field of aircraft structures. So, torsion boxes currently constitute the main structural element of the wings and the horizontal tail plane in aircraft.

A torsion box is essentially defined as a structure consisting of: some spars, normally straight, arranged longitudinally in the structure; some ribs, which are arranged transversely across the spars and joined to them; and a skin, which covers the structure around the spars and the ribs, and is joined to them.

The spars fundamentally have the function of absorbing bending stresses, the ribs for their part distribute the stresses along the spars and give form to the skin, and finally the skin distributes to the ribs and spars the aerodynamic loads of lift and resistance which are applied on the aerodynamic surface of the skin. In addition, torsion boxes usually incorporate some stringers which are arranged attached to the inner surface of the skin and which contribute the function of providing stability to the skin and preventing it from buckling.

The outer surface of the skin of torsion boxes for aeronautical use requires very narrow tolerances, of the order of 0.01 mm, bearing in mind that there are aerodynamic forces acting on that surface. It is for this reason that the fitting of the skin on these structures acquires special importance.

Finally, it can be pointed out that, although the present invention refers to torsion boxes for aeronautical use, it must not be understood as being restricted thereto since, as revealed from the description that is made below, it can also be applied to structures consisting of a skeletal framework that gives exterior form and a substantially flaccid skin in which it needs to be made sure that the outer surface of the skin has certain dimensional tolerances.

### BACKGROUND OF THE INVENTION

Conventionally, and for the assembly of structures such as torsion boxes for aeronautical use, as well as other structures of considerable size, a support structure is used for the different elements to be fitted, known as an assembly jig.

The technique used for the assembly of structures such as torsion boxes consists of the following basic operations: support; positioning; temporary fixing; and join.

Support is understood to be the arrangement of elements to be fitted in an assembly jig.

Positioning is the operation consisting of determining the correct position of the element to fit with respect to other elements of the structure, in other words, the referencing of the element and the location of the element in that position.

The operation of temporary fixing consists of making a temporary join prior to the final join between the elements making up the structure to assemble. In riveted joins, the temporary join is conventionally done by means of some assembly clamps which are arranged traversing the surfaces of the elements to attach, following a prior drilling of those surfaces. The aim of the temporary fixing is to systematize and facilitate the assembly by permitting elements to be added or removed during the assembly and thereby, for example, allow access to other assembly elements, for tools, operators, etc.

Finally, join is the operation of final fixing between the elements to fit. The join between the elements of torsion boxes for aeronautical use is usually done by means of riveting.

Temporary fixing and the join between the different elements of a torsion box is conventionally done by means of overlapping by some extensions made in the elements to attach or pieces included in them. So, the edge of the rib typically has some flanges for its join to the skin and some flaps for its join to the spars, while for their part the inner faces of the spars have some reinforcements via which they are attached to the ribs.

The conventional method for assembly of torsion boxes for aeronautical use basically consists of first assembling the structure of the skeleton of the torsion box, in other words, the spars and the ribs, and, once the skeleton has been assembled, the skin is fitted to it.

Described below in detail is a conventional method for the assembly of a torsion box.

First, the spars are supported and positioned on the assembly jig, correctly referenced.

Then the ribs are positioned longitudinally and transversely, in other words in the direction longitudinal and transverse to the spars respectively. The longitudinal positioning of the ribs is done on the basis of reinforcements provided on the inner face of the spars with the task of acting as their join to the ribs. The transverse positioning is obviously more critical from the point of view of dimensional tolerances, and cannot be carried out on the basis of reinforcements of the spars as with the longitudinal positioning. For this purpose, an auxiliary device is conventionally used which essentially consists of some stops or templates that limit the internal contour of the skin and therefore predefine the correct position of the ribs when making contact with those stops or templates. Once each rib has been positioned, it is temporarily fixed to the spars, by means of clamping with the assembly clamps.

Next, the join is carried out between the spars and the ribs, with the temporarily fixings being replaced by the final ones, usually by means of drilling and riveting.

Finally, once the skeleton of the structure, formed from the spars and the ribs, has been assembled, the skin is then proceeded to be fitted. To achieve this, the skin is brought up to the ribs and spars and laid over them in its correct position. The positioning of the skin is carried out in such a way that each one of the upper and the lower parts or portions (as well so-called upper skin and lower skin) making up the torsion box extends from the longitudinal central line of the skin as far as the spars, adjusting and ensuring contact with the flanges of the ribs.

The assembly has to reflect the theoretical design of the structure exactly, nevertheless it is not unusual that, following the assembly, the surface of the skin is outside of its tolerance, with projecting zones and sunken zones inevitably being produced in the surface of the skin. This can be due to manufacturing errors such as deviations in the angle of opening of the flanges or deviations in the thickness of the skin, though it is mainly due to assembly errors on account of imprecise positioning of the rib, above all as a consequence of the intrinsic inaccuracy of the system of positioning the ribs based on the use of the said stops or templates.

In order to solve these defects in assembly of the skin and thereby ensure the required tolerances, certain operations known as adjustment operations are currently carried out, before making the final join. These adjustment operations essentially consist of making local modifications in the join zone of the flanges of the ribs with the skin, in which the flanges are deformed, by cutting them or filling the gaps with supplementary pieces, either fluid or solid. These adjustment operations present the drawback that they are very laborious and therefore considerably increase the cost of the assembly method.

As has been seen, some of the drawbacks shown by the conventional method for assembly of torsion boxes are: inaccuracy of the aerodynamic surface of the skin following the assembly; the complexity of the positioning system for the ribs (stops or templates); and the carrying out of laborious adjustment operations.

### DESCRIPTION OF THE INVENTION

The method proposed in the present invention aims to avoid the drawbacks stated above, permitting torsion boxes to be obtained that are more accurate in the aerodynamic surface of the skin, simplifying the assembly and eliminating unnecessary adjustment operations, thereby achieving a reduction in cost and an improvement in the performance of the torsion boxes produced.

The assembly method for torsion boxes for aeronautical use of the present invention basically consists of assembling the skeleton of the torsion box (spars and ribs) simultaneously with the skin, in such a way that the ribs are positioned with reference to the skin, being temporarily fixed to the latter once positioned, rather than to the spars.

The skin of the torsion boxes for aeronautical use has the nature of being flaccid, flaccid being understood as the fact that the skin, prior to being assembled on the skeleton of the structure, does not per se have the form that it acquires once assembled, instead, its form can vary, and in particular it can be observed that the skin of torsion boxes is primarily flaccid in the transverse direction since longitudinally they are stiffened by the stringers.

This characteristic that the skin is flaccid has the consequence that, in order to be able to position the ribs correctly against the skin, it is necessary on the one hand to provide the skin with the theoretical form that it has to acquire once assembled on the structure and, on the other hand, to provide means so that during assembly the skin firmly maintains that theoretical form without undergoing any deformations or other alterations deriving from the actual manipulation of the skin during assembly.

This basic operation consisting of giving form to the skin and maintaining that form during the assembly is known as the pre-forming operation, and is sui generis of the method of the invention that is claimed.

The present invention also claims a device for carrying out the pre-forming operations known as the device for pre-forming.

The device for pre-forming of the present invention essentially consists of a template element that is basically characterized by the fact that when the skin is forced on the template element the outer surface of the skin acquires its exact theoretical form and in that it has means for securing and tightening of the skin, with the aim of maintaining the form of the skin. So, the means of securing and tightening have to provide the skin with the right internal tension so that it does not deform when carrying out the operations of the method. In order to achieve this, a characteristic of the device for pre-forming is that the means of securing of the skin are such that no local deformations are introduced at the securing points plus the fact that these are conveniently distributed. Another additional characteristic of the device for pre-forming is that the means of securing and tightening are arranged in such a way that they permit the passage of drill-bits and fixings along with the proper carrying out of the operations of the method.

Described below in detail is an assembly method of a torsion box according to the invention that is claimed.

As with the conventional method described above, the spars are positioned and supported, properly referenced, on an assembly jig.

Next the ribs are positioned. The longitudinal positioning is carried out in the same way as for the conventional method already described, starting from the reinforcements of the spars. The difference with the conventional method lies in the transverse positioning of the ribs which, as has been described, is carried out by means of a pre-formed skin and essentially consists of determining the correct transverse position of the ribs with the condition that these connect against the pre-formed skin, in such a way that, by means of rotations or displacements in the assembly plane of the ribs their best seating against the skin is encountered.

When the ribs are being positioned, they are temporarily fixed to the pre-formed skin and to the spars, with the corresponding clamping being carried out.

Finally, the join operations among the spars, the ribs and the skin are carried out, replacing the temporary fixings for final joins, usually by means of drilling and riveting.

A variant of the method of the invention described above consists of separately carrying out the assembly of one of the portions of skin (the upper and the lower) and afterwards the other portion of skin. This variant demonstrates the utility of torsion boxes that incorporate ribs divided into portions so, with the ribs that incorporate a portion of the upper rib and another portion of the lower rib; it is possible to achieve a better adjustment as a result of applying the assembly method of the invention. In this variant, the method would consist of first assembling a portion of skin, pre-forming that portion and temporarily fixing the portions of respective ribs to that portion of pre-formed skin and afterwards that portion of the rib would be attached to the spars withdrawing the portion of skin, and then the other portion of skin would be assembled likewise proceeding to temporarily fix the portions of the rib also with the other portions of the rib already assembled, and finally the portions of skin and the spars, if appropriate, are attached together with the portions of skin.

### BRIEF DESCRIPTION OF THE FIGURES

The present invention will be fully understood on the basis of the brief description appearing below and on the accompanying drawings which are presented by way of example only and are thereby not restrictive within the present invention and where:

FIG. 1 shows an exploded perspective view of a torsion box structure for aeronautical use with the elements constituting it and whose assembly forms the object of the present invention: spars, ribs and skin.

FIG. 2 shows a perspective view of a type of rib described in an embodiment of the invention consisting of a portion of the upper rib and a portion of the lower rib..

FIG. 3 schematically represents a sequence of the assembly method of a torsion box structure showing a view of the structure in the different steps making up the assembly sequence.

FIG. 4 shows a schematic perspective view of a device for pre-forming used in the assembly method, with reference to an assembly jig in which the spars are shown positioned and supported on that jig.

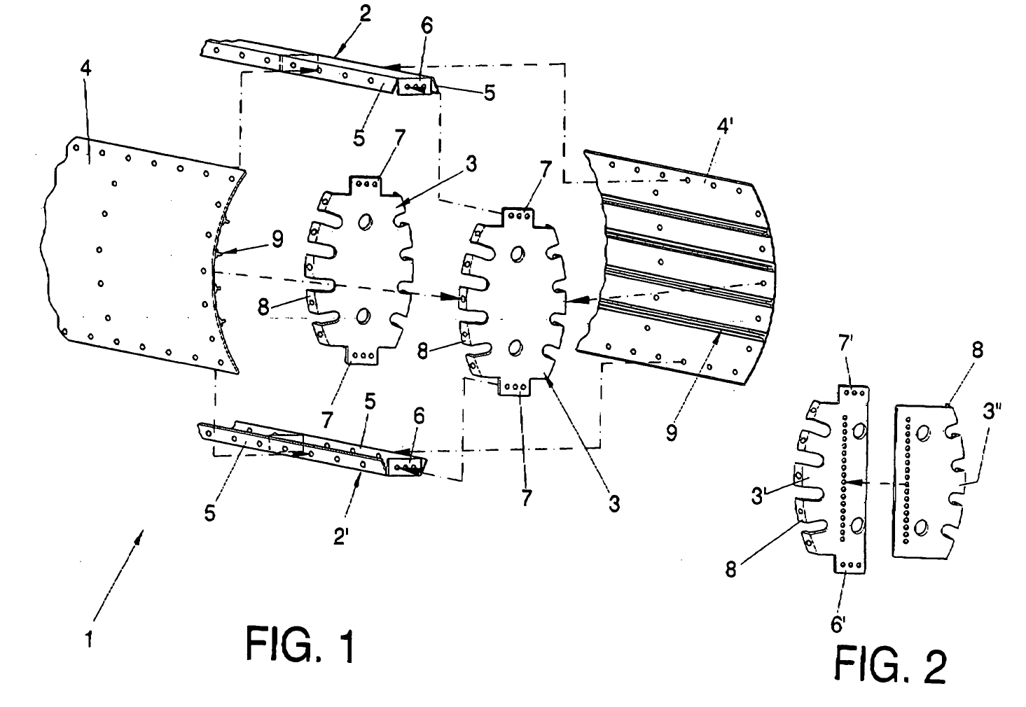

### EMBODIMENT OF THE INVENTION

With the aim of arriving at a better understanding of the object and functionality of this patent, and without being regarded as restrictive solutions, given below is a description of an embodiment of the invention based on the figures stated above.

The embodiment that is described below relates to an assembly method for a torsion box (1) for aeronautical use as shown in the figures, whose constituent elements to assemble are essentially the following:

A forward spar (2) and a rear spar (2′), arranged longitudinally in the structure;

Some ribs (3) attached to the spars (2, 2′) and arranged transversely in the structure, which in the present embodiment consists of an upper portion of rib (3′) and a lower portion of rib (3″) in each of them; and

A skin (4, 4′) arranged covering the structure around the spars and the ribs and attached to them, including an upper portion of skin (4) and a lower portion of skin (4′) (as well so-called upper skin and lower skin respectively); ensuring with the method certain dimensional tolerances required in the aerodynamic outer surface of the skin (4, 4′). The skin is provided with some stringers (9).

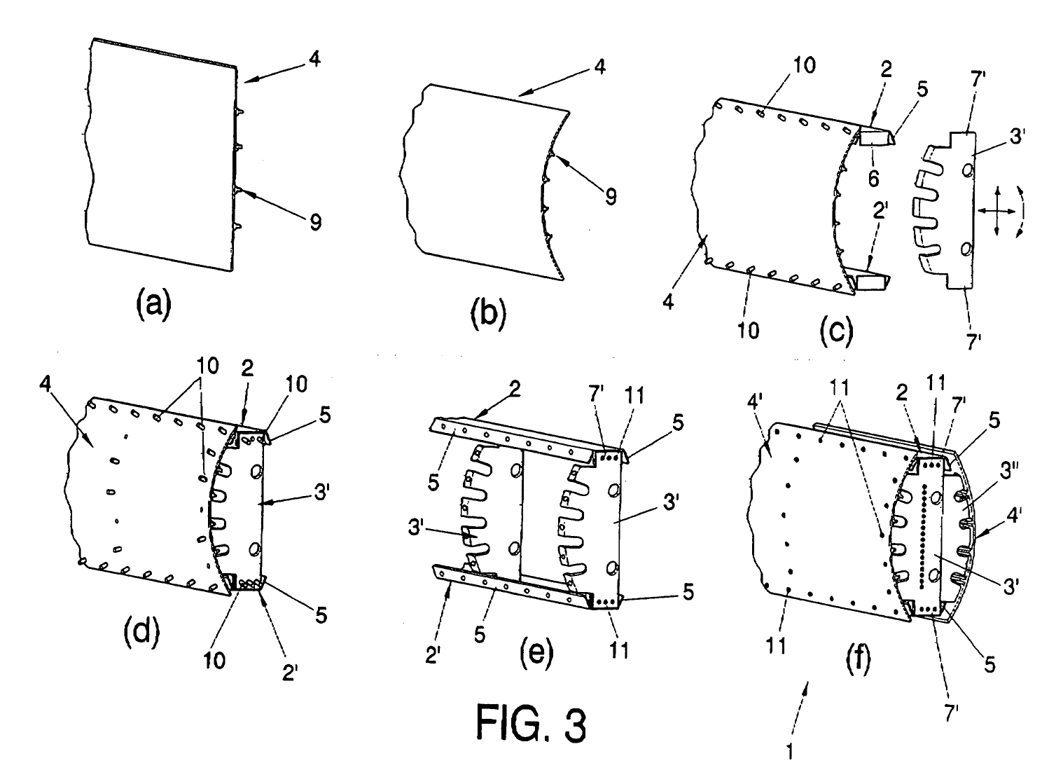

Described below is the assembly method of the invention applied to the said torsion box structure (1), making reference to FIG. 3.

One starts from the upper portion of skin (4) without the appropriate form (FIG. 3a) since it is flaccid; by means of the pre-forming operation and using a device for pre-forming, the upper portion of skin (4) is forced into the theoretical form (FIG. 3b) which it has to acquire once it has been assembled on the structure in such a way that said theoretical form is maintained firm during the assembly.

Once the portion of skin (4) is pre-formed, it is brought up to the forward and rear spars which have been previously positioned in the assembly jig with the correct reference. At this moment the temporary fixing is carried out between the portion of skin (4) and the spars (2, 2′) via the flanges (5) of the spars, using assembly clamps (10).

The positioning of the upper portions of the ribs (3′) is then carried out and they are given the corresponding adjustment against the inner surface of the skin by means of suitable rotations and displacements of the rib in the transverse plane (FIG. 3c). This adjustment can be carried out with the aid of mechanical manipulation means.

FIG. 3d shows the temporary fixing operation of the upper portions of ribs, which is carried out once each portion of the rib has been positioned. The fixing is done by overlapping of the extensions (7′) of the portions of the ribs with the reinforcements (6) of the spars (2, 2′) and the portion of skin (4).

The next step is to withdraw the portion of the upper skin and to attach the portions of the ribs to the spars, replacing the clamps (10) for rivets (11), shown in FIG. 3e.

The rest of the assembly method consists of assembling the other part of the torsion box (1) to the lower portion of skin (4′) and the lower portions of the ribs (3″)). The steps to follow are analogous to the steps described for the assembly of the part of the torsion box (1) formed from the upper portion of skin (4) and the upper portions of the ribs (3′), mutatis mutandi, bearing in mind that the lower portion of the rib (3″) overlaps the upper portion of the rib (3′).

Finally, the temporary fixings are replaced with joins and the two portions of the upper (4) and the lower (4′) skins are joined to the set of spars (2, 2′) and the ribs (3′, 3″). FIG. 3f shows the assembled torsion box structure (1).

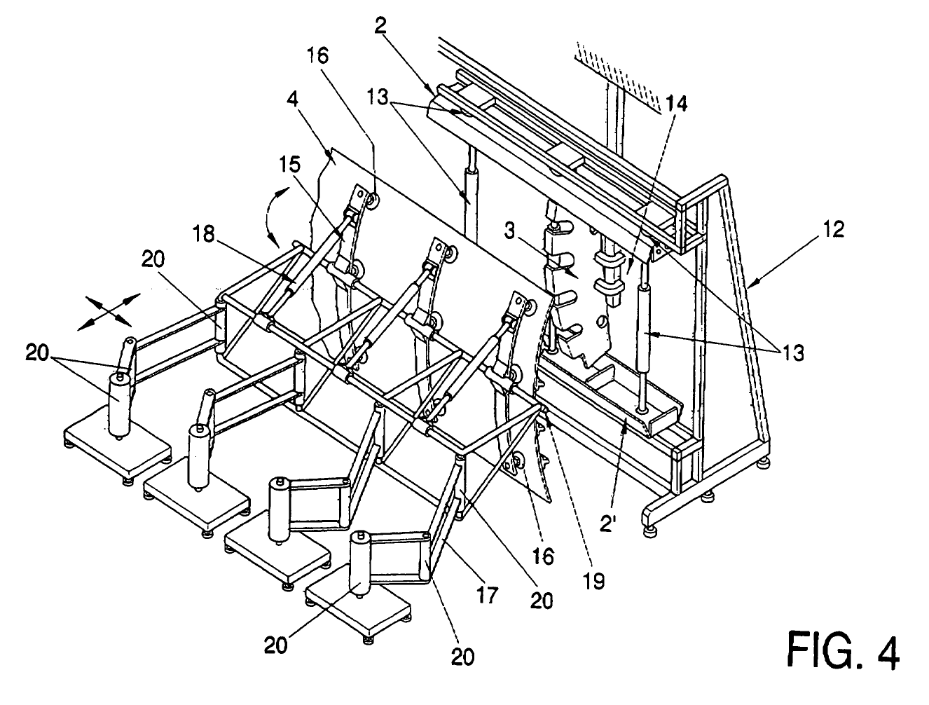

In FIG. 4 an embodiment can be seen of a device for pre-forming according to the present invention and its arrangement with respect to the assembly jig (12) of the torsion box, where the spars (2, 2′) are supported and positioned using conventional positioning means (13). Also shown are conventional means of mechanical manipulation of the ribs (14) which are suspended from a gantry crane.

The device for pre-forming of the embodiment includes a template element (15) such that when the skin is forced on the template element the outer surface of the skin (4, 4′) acquires its exact theoretical form and it maintains that form, for which it is provided with means of securing and tightening (15) of the skin (4, 4′). The device also includes some means of support and positioning (16, 17, 18, 19) of the template element (15), consisting of means of translation (16, 19) and means of positioning in spatial rotation (17, 18), with the function of positioning the skin (4, 4′) in the structure with the exact theoretical form according to the described method.

1. METHOD FOR ASSEMBLYING A STRUCTURE FOR AN AIRCRAFT, the structure essentially consists of:
a set of structural elements which together constitutes a skeleton of the structure; and
a skin that is arranged covering the structure around the skeleton and connected to it; the skin being substantially flaccid in such a manner that it substantially has an indeterminate form per se until it is arranged connected on the skeleton; the skin having an outer surface which requires dimensional tolerances thereon once the skin is assembled on the skeleton;
the method comprising the following steps:
a) Pre-forming the skin; this step essentially consisting of giving a shape to the skin in order to achieve the exact theoretical form that the skin should have once assembled on the skeleton of the structure, as well as firmly maintaining that form, in such a manner that the skin not being deformed or undergone alterations during its manipulation in the assembly;
b) Positioning and temporary fixing the skeleton of the structure, with respect to the pre-formed skin; this step essentially consisting of determining the relative position between the structural elements constituting the skeleton with the condition that the skeleton connects against the pre-formed skin, as well as temporarily attaching the pre-formed skin to the skeleton and the elements constituting the skeleton to each other.
c) Final join of the skeleton to the skin.

2. METHOD FOR ASSEMBLYING A STRUCTURE FOR AN AIRCRAFT, according to claim 1, applied to a torsion box structure type (1) which essentially consists of:
a skeleton, comprising: a plurality of spars (2) arranged longitudinally in the structure, and a plurality of ribs (3) arranged transversely in the structure; and
a skin (4, 4′) arranged covering the structure around the spars and the ribs and attached to them; the skin having an aerodynamic outer surface which requires dimensional tolerances thereon once the skin is assembled on the skeleton;
the method comprising the following steps:
a) Pre-forming the skin; this step essentially consisting of deforming the skin in order to achieve the exact theoretical form that the skin should have once assembled on the spars (2) and the ribs (3) of the torsion box structure (1); b.1) Positioning the spars (2); this step essentially consisting of supporting the spars in an assembly jig (12), such that the exact relative position existing between the spars in the assembled structure of the torsion box structure (1) remains fixed.
b.2) Positioning and temporary fixing the pre-formed skin to the spars; this step essentially consisting of locating the pre-formed skin onto the spars in the correct position that the skin occupies in the assembled structure of the torsion box (1), and provisionally joining the pre-formed skin and the spars to each other.
b.3) Positioning and temporary fixing the ribs to the pre-formed skin and to the spars; essentially consisting of locating the ribs in their correct position with the condition that the ribs connect against the pre-formed skin, and provisionally joining the ribs to the pre-formed skin and the spars.
c.1) Final join the spars to the ribs.
c.2) Final join the skin to the spars and the ribs.

3. METHOD FOR ASSEMBLYING A STRUCTURE FOR AN AIRCRAFT, according to claim 2, applied to a torsion box structure (1) type which essentially consists of:
a skeleton, comprising: a front spar (2) and a rear spar (2′) arranged longitudinally in the structure, and a plurality of ribs (3) arranged transversely in the structure, each of the ribs comprising an upper portion of the rib (3) and a lower portion of the rib (3′); and
a skin, comprising an upper portion of the skin (4) and a lower portion of the skin (4′), arranged covering the structure around the spars and the ribs and attached to them; the skin having an aerodynamic outer surface which requires dimensional tolerances thereon once the skin is assembled on the skeleton;
the method comprising the following steps:
1.a) Pre-forming one of the portions of the skin, that is the upper (or the lower) portion of the skin; this step essentially consisting of deforming the portion of the skin in order to achieve the exact theoretical form that it should have once assembled on the spars (2) and the ribs (3) of the torsion box structure (1);
1.b.1) Positioning the spars (2); this step essentially consisting of supporting the spars on an assembly jig (12), such that the exact relative position existing between the front spar and the rear spar of the assembled structure of the torsion box structure (1) remains fixed.
1.b.2) Positioning and temporary fixing the pre-formed portion of the skin to the spars; this step essentially consisting of locating the pre-formed portion of the skin onto the spars in the correct position that the portion of the skin occupies in the assembled structure of the torsion box structure (1), and provisionally joining the pre-formed portion of the skin and the spars to each other.
1.b.3) Positioning and temporary fixing the upper (or the lower) portions of the ribs to the pre-formed portion of the skin and to the spars; essentially consisting of locating the portions of the ribs in their correct position with the condition that the portions of the ribs connect against the pre-formed portion of the skin, and provisionally joining the upper (or the lower) portions of the ribs to the pre-formed portion of the skin and the spars. 1.c.1) Final join the spars to the upper (or the lower) portions of the ribs.
1.c.2) Final join of the portion of the skin to the spars and the upper (or the lower) portions of the ribs.
2.a) Pre-forming the other portion of the skin, that is the lower (or the upper) portion of the skin; this step essentially consisting of deforming the portion of the skin in order to achieve the exact theoretical form that the portion of the skin should have once assembled on the spars (2) and the ribs (3) of the torsion box structure (1);
2.b.1) Positioning and temporary fixing the pre-formed portion of the skin to the spars; this step essentially consisting of locating the pre-formed portion of the skin onto the spars in the correct position that the portion of the skin occupies in the assembled structure of the torsion box structure (1), and provisionally joining the pre-formed portion of the skin and the spars to each other.
2.b.2) Positioning and temporary fixing the lower (or the upper) portions of the ribs to the pre-formed portion of the skin, to the upper (or the lower) portions of the ribs and, as the case might be, to the spars; this step essentially consisting of locating the portions of the ribs in their correct position with the condition that the portions of the ribs connect against the pre-formed portion of the skin, and provisionally fixing to the lower (or the upper) portions of rib to the lower (or the upper) pre-formed portions of the skin and to the upper (or the lower) portions of the ribs and, as the case might be, to the spars.
2.c.1) Final join the upper portions of the ribs to the lower portions of the ribs and, as the case might be, to the spars.
2.c.2) Final join the portions of the skin (the upper and the lower) to the spars and to the portions of the ribs ( the upper and the lower).

4. METHOD FOR ASSEMBLYING A STRUCTURE FOR AN AIRCRAFT, according to claim 3, wherein the torsion box structure (1) remains substantially vertical during the assembly in such a way that the front (2) and the rear (2) spars are positioned arranged one on top of the other and the upper (4) and the lower (4′) portions of the skin are located in the respective sides.

5. DEVICE FOR PRE-FORMING THE SKIN OF A STRUCTURE FOR AN AIRCRAFT, applied to the method described in claim 1; comprising:
a template element having means for securing and tightening the skin such that when the skin is forced on the template element the outer surface of the skin acquires its exact theoretical form and maintains that form via providing the skin the right internal tension so that it does not deform when carrying out the operations of the method, the means of securing and support being arranged in such a way that they permit the carrying out of the operations of the method;
means for supporting and positioning the template element, comprising means for positioning in translation and means for positioning in three-dimensional rotation, with the function of positioning the skin on the skeleton of the structure according to the described method.

6. DEVICE FOR PRE-FORMING THE SKIN OF A STRUCTURE FOR AN AIRCRAFT, according to claim 5; wherein the means of securing and tightening the skin incorporate a securing device by vacuum, which comprises a set of suction pads (15) distributed on the template element.

7. DEVICE FOR PRE-FORMING THE SKIN OF A STRUCTURE FOR AN AIRCRAFT, according to claim 6; wherein the template element (15) essentially consists of curved profiles with the shape corresponding to the theoretical line of the outer surface of the skin.

8. DEVICE FOR PRE-FORMING THE SKIN OF A STRUCTURE FOR AN AIRCRAFT, applied to the method described in claim 2; comprising:
a template element having means for securing and tightening the skin such that when the skin is forced on the template element the outer surface of the skin acquires its exact theoretical form and maintains that form via providing the skin the right internal tension so that it does not deform when carrying out the operations of the method, the means of securing and support being arranged in such a way that they permit the carrying out of the operations of the method;
means for supporting and positioning the template element, comprising means for positioning in translation and means for positioning in three-dimensional rotation, with the function of positioning the skin on the skeleton of the structure according to the described method.

9. DEVICE FOR PRE-FORMING THE SKIN OF A STRUCTURE FOR AN AIRCRAFT, according to claim 8; wherein the means of securing and tightening the skin incorporate a securing device by vacuum, which comprises a set of suction pads (15) distributed on the template element.

10. DEVICE FOR PRE-FORMING THE SKIN OF A STRUCTURE FOR AN AIRCRAFT, according to claim 9; wherein the template element (15) essentially consists of curved profiles with the shape corresponding to the theoretical line of the outer surface of the skin.

11. DEVICE FOR PRE-FORMING THE SKIN OF A STRUCTURE FOR AN AIRCRAFT, applied to the method described in claim 3; comprising:
a template element having means for securing and tightening the skin such that when the skin is forced on the template element the outer surface of the skin acquires its exact theoretical form and maintains that form via providing the skin the right internal tension so that it does not deform when carrying out the operations of the method, the means of securing and support being arranged in such a way that they permit the carrying out of the operations of the method;
means for supporting and positioning the template element, comprising means for positioning in translation and means for positioning in three-dimensional rotation, with the function of positioning the skin on the skeleton of the structure according to the described method.

12. DEVICE FOR PRE-FORMING THE SKIN OF A STRUCTURE FOR AN AIRCRAFT, according to claim 11; wherein the means of securing and tightening the skin incorporate a securing device by vacuum, which comprises a set of suction pads (15) distributed on the template element.

13. DEVICE FOR PRE-FORMING THE SKIN OF A STRUCTURE FOR AN AIRCRAFT, according to claim 12; wherein the template element (15) essentially consists of curved profiles with the shape corresponding to the theoretical line of the outer surface of the skin.

14. DEVICE FOR PRE-FORMING THE SKIN OF A STRUCTURE FOR AN AIRCRAFT, applied to the method described in claim 4; comprising:
a template element having means for securing and tightening the skin such that when the skin is forced on the template element the outer surface of the skin acquires its exact theoretical form and maintains that form via providing the skin the right internal tension so that it does not deform when carrying out the operations of the method, the means of securing and support being arranged in such a way that they permit the carrying out of the operations of the method;
means for supporting and positioning the template element, comprising means for positioning in translation and means for positioning in three-dimensional rotation, with the function of positioning the skin on the skeleton of the structure according to the described method.

15. DEVICE FOR PRE-FORMING THE SKIN OF A STRUCTURE FOR AN AIRCRAFT, according to claim 14; wherein the means of securing and tightening the skin incorporate a securing device by vacuum, which comprises a set of suction pads (15) distributed on the template element.

16. DEVICE FOR PRE-FORMING THE SKIN OF A STRUCTURE FOR AN AIRCRAFT, according to claim 15; wherein the template element (15) essentially consists of curved profiles with the shape corresponding to the theoretical line of the outer surface of the skin.
